(19) United States
(12) Patent Application Publication
(10) Pub. No.: US 2004/0215909 A1
(43) Pub. Date: Oct. 28, 2004

(54) Nonvolatile memory device and data processing system

(75) Inventors: Tsutomu Imai, Tachikawa (JP); Akira Kanehira, Toshima (JP); Kunihiro Katayama, Chigasaki (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 10/825,674

(22) Filed: Apr. 16, 2004

(30) Foreign Application Priority Data
Apr. 23, 2003 (JP) 2003-117822

(51) Int. Cl. G06F 12/14

(52) U.S. Cl. 711/163; 711/103

(57) ABSTRACT

The disclosed invention effectively prevents fraudulent access to data whose usage is restricted to a time limit, such access attempted by manipulating the clock internal to a playback device and a terminal device. A nonvolatile memory device of the invention comprises a control circuit and a nonvolatile memory circuit which includes a storage region for restriction information to restrict access to contents information provided by web-based rental service. The restriction information includes access time limit information and access time stamp information. The control circuit performs an access decision action which comprises deciding whether access to the contents information is enabled or disabled, based on real time information which is supplied externally and the restriction information, and updating the access time stamp information to the real time information. The control circuit decides that access is disabled if the real time information is later than the access time limit given by the access time limit information or if the real time information is earlier than the access time stamp given by the access time stamp information; otherwise, the control circuit decides that the access is enabled. The control circuit performs the access decision action, at least, at the start of access to said contents information and at the end of the access.

### CROSS-REFERENCE TO RELATED APPLICATION

The present application claims priority from Japanese patent application JP 2003-117822 filed on Apr. 23, 2003, the content of which is hereby incorporated by reference into this application.

### BACKGROUND OF THE INVENTION

The present invention relates to playback time limit management of contents data such as moving pictures and music stored on a storage medium and, more particularly, to nonvolatile memory, playback terminal, and distribution terminal devices to which playback time limit management and control are applied.

Once web-based contents such as picture and music data have been downloaded for rental use and stored into a storage medium such as a memory card, users can play back the picture and music with a playback device as long as within a playback time limit that has been set for the contents in advance. The playback management is performed, based on time measured by the user's playback device and playback time limit information that was written simultaneously with the digital data of the downloaded contents stored into the storage medium. If the user maliciously alters the present time value measured by the user's playback device, the user can play back the contents even if out of the playback time limit.

As a countermeasure against this alteration of the time value measured by the playback device, for example, a technique described in Japanese Patent Document Cited 1 has been offered. According to this technique, a data writing device sets a time limit by which data can be output from a data reading device and writes the data, time limit, and the date and time of writing of the data and time limit into the storage medium. The data reading device decides whether the data written into the storage medium can be output, based on the time limit and the date and time of writing that it has read from the storage medium and the present time value measured by it. If the data can be output, the reading device reads the data from the storage medium and outputs it. Suppose that, when it is out of the time limit by which the data can be output, the user alters the present time value measured by a time measurement means of the data reading device to a time value earlier than the date and time of writing and attempts to make the reading device output the data deceitfully. In that case, a decision means does not decide that the data can be output, because the present time value altered by fraud is earlier than the time at which the data was written. Moreover, the date and time of writing is updated to the preset time value when a playback process finishes.

[Japanese Patent Document Cited 1]

Japanese Unexamined Patent Publication No. 2002-259917 (Para 99, FIG. 7)

### SUMMARY OF THE INVENTION

The inventors of this invention have found that, according to the technique disclosed in the above Japanese Patent Document Cited 1, by recording time data on the storage medium such as a memory card, a fraudulent playback of contents whose usage is restricted to a time limit can be prevented even if such a fraudulent playback is attempted by manipulating the internal clock of the playback terminal device, but this preventive means is not sufficient. Firstly, there are conceivable cases where this prevention is insufficient only by updating the time value retained on the storage medium to the present time value when a playback finishes. For example, if the power supply to the device is turned off immediately before a playback of the contents finishes, the time value retained on the storage medium is not updated. Secondly, because the playback device is provided with the function to prevent a fraudulent playback of contents whose usage is restricted to a time limit, after replacing the playback device, fraudulent access to the contents is still possible.

It is an object of the present invention to provide a technique for effectively preventing fraudulent access to data whose usage is restricted to a time limit; such access, otherwise, would be conceivable to be possible by manipulating the internal clock of the playback device and the terminal device.

The above object and other objects and novel features of the present invention will become apparent from the following description of the present specification and the accompanying drawings.

Typical aspects of the invention disclosed in this application can be summarized as follows.

Nonvolatile Memory Device

In the first facet of the present invention, a nonvolatile memory device, as the storage medium, has the function to prevent fraudulent access to data whose usage is restricted to a time limit.

[1] A nonvolatile memory device according to the present invention comprises a control circuit and a nonvolatile memory circuit. The nonvolatile memory circuit includes a storage region for restriction information that restricts access to contents information provided by web-based rental service. The restriction information includes access time limit information and access time stamp information. The control circuit performs an access decision action which comprises deciding whether access to the contents information is enabled or disabled, based on real time information which is supplied externally and the restriction information, and updating the access time stamp information to the real time information. The control circuit decides that access is disabled in the case where the real time information is later than the access time limit given by the access time limit information or in the case where the real time information is earlier than the access time stamp given by the access time stamp information, and in the case other than these cases, the control circuit decides that the access is enabled. The control circuit performs the access decision action, at least, at the start of access to said contents information and at the end of the access.

Through the above means, time data like the access time stamp information is updated and recorded on the nonvolatile memory device such as a memory card. Each time the access time stamp is updated, the interval between the time given by the access time stamp information and the time given by the time limit information becomes shorter, and eventually the time given by the access time stamp information goes beyond the time given by the time limit information. Once it goes beyond the time limit, it is impossible to access the contents. Even if the user backdates the terminal internal clock to date and time prior to the usable time limit, it is no longer allowed to play back the contents. Consequently, a fraudulent playback of contents whose usage is restricted to a time limit can be prevented even if such a fraudulent playback is attempted by manipulating the clock internal to a terminal such as a playback device. Because the access time stamp information is updated not only at the timing of the end of access to the contents, but also at the timing of the start of the access, it is ensured that the access time stamp information is updated at least once per access even if the power supply is turned off immediately before the termination of a playback of the contents information. Because the nonvolatile memory device is provided with the function to prevent a fraudulent playback of contents information with a usable time limit, it is easy to keep the function to prevent fraudulent access still working even after the playback device is replaced.

[2] The access decision action may be performed, at least, when operating power supply to the nonvolatile memory device is turned on, and when the operating power supply is turned off.

[3] Furthermore, the access decision action may be performed at another timing. When a plurality of divisions of contents information are accessed discretely, after the access decision action decides that initial access to one of the divisions is enabled, the access decision action may be performed each time accessing each of or a given number of the remaining divisions of the contents information.

[4] The divisions of the contents information are accessed in units of sectors.

[5] The access decision action for access to the divisions of the contents information may be programmed such that the access decision action for access to the second and subsequent divisions of the contents information decides that access is enabled even if the real time information is later than the access time limit given by the access time limit information. This can simply eliminate the following inconvenience for the user: as the access decision action is repeated for contents information, the time limit comes during the playback of the contents information and the playback is stopped.

[6] The nonvolatile memory device is used, connected to an external device, for example, a device that can output the real time information, and the nonvolatile memory device can output the divisions of the contents information to the external device.

[7] The nonvolatile memory circuit is, for example, a nonvolatile semiconductor memory, and is housed in a certain memory card casing having interface terminals for connection to an external device.

[8] The restriction information is encrypted by the control circuit and stored into the nonvolatile memory circuit. If the restriction information is stored into an unrestricted access region, this implementation is simple and favorable.

[9] For an encryption key that is used to encrypt the restriction information, for example, attribute information unique to the nonvolatile memory device can be used.

[10] If copyright should be taken into consideration, the control circuit preferably can output certificate information to the external in order to receive a contents information license including a contents key that is used to decrypt the contents information.

[11] If the certificate information is authenticated at the external, the control circuit preferably can receive the contents information license from the external and store the received license into the nonvolatile memory circuit.

[12] It is preferable that the control circuit stores time information that is input with the contents key into the nonvolatile memory circuit as an initial value of the access time stamp information. Such time information is obtained with a very low possibility of being tampered with.

[13] Consider a restricted access region such as a secure region. When the nonvolatile memory circuit comprises a restricted access region and an unrestricted access region, it is favorable to store the restriction information into the restricted access region and store the contents information into the unrestricted access region.

[14] Consider authentication for write access to the restricted access region. Preferably, the control circuit is allowed to write data into the restricted access region only after authentication is accepted from the external. Unauthorized writing to the restricted access region is protected.

[15] The restricted access region is to store, for example, the contents information license.

[16] Consider authentication for write access to the restricted access region. The control circuit is allowed to read data from the restricted access region only after certificate information given from the external is authenticated. Unauthorized reading from the restricted access region can be protected.

Playback Terminal Device

In the second facet of the present invention, a data processing system such as a playback terminal has the function to prevent fraudulent access to data whose usage is restricted to a time limit.

[17] A data processing system according to the present invention comprises a playback unit and a usage restriction unit and can play back contents information provided by web-based rental service through access to a storage medium which rewritably stores restriction information to restrict access to the contents information. The restriction information includes access time limit information and access time stamp information. The usage restriction unit performs an access decision action which comprises deciding whether access to the contents information is enabled or disabled, based on real time information which is generated in the data processing system and the restriction information, and updating the access time stamp information which is retained on the storage medium to the real time information. The usage restriction unit decides that access is disabled in the case where said real time information is later than the access time limit given by the access time limit information or in the case where said real time information is earlier than the access time stamp given by said access time stamp information, and in the case other than these cases, said control circuit decides that the access is enabled. The usage restriction unit performs the access decision action, at least, at the start of access to said contents information and at the end of the access.

Through the above means, time data like the access time stamp information is updated and recorded on the storage medium such as a memory card. Each time the access time stamp is updated, the interval between the time given by the access time stamp information and the time given by the time limit information becomes shorter, and eventually the time given by the access time stamp information goes beyond the time given by the time limit information. Once it goes beyond the time limit, it is impossible to access the contents. Even if the user backdates the terminal internal clock to date and time prior to the usable time limit, it is no longer allowed to play back the contents. Consequently, a fraudulent playback of contents whose usage is restricted to a time limit can be prevented even if such a fraudulent playback is attempted by manipulating the clock internal to a terminal such as a playback device. Because the access time stamp information is updated not only at the timing of the end of access to the contents, but also at the timing of the start of the access, it is ensured that the access time stamp information is updated at least once per access even if the power supply is turned off immediately before the termination of a playback of the contents information.

[18] The access decision action may be performed, at least, when the storage medium is installed in the playback unit and when the storage medium is removed from the playback unit.

[19] In another aspect, the access decision action may be performed when operating power supply is turned on with the storage medium installed in the playback unit and when the operating power supply is turned off with the storage medium installed in the playback unit.

[20] The usage restriction unit encrypts the access time stamp information with an encryption key of attribute information unique to the storage medium and updates the access time stamp information. If the access time stamp information is stored into an unrestricted access region, this implementation is simple and favorable.

[21] The storage medium is, for example, a rewritable nonvolatile memory device.

[22] Consider the restricted access region such as a secure region. When the nonvolatile memory device comprises a restricted access region and an unrestricted access region, the usage restriction unit accesses restriction information which is stored in the restricted access region and the playback unit accesses contents information which is stored in the unrestricted access region.

[23] Consider authentication for write access to the restricted access region. Preferably, the usage restriction unit is allowed to write data into the restricted access region only after certificate information output from the nonvolatile memory device is authenticated. Unauthorized writing to the restricted access region is protected.

[24] The restricted access region is to store a contents information license that is used to decrypt the contents information.

[25] Consider authentication for read access to the restricted access region. Preferably, the usage restriction unit is allowed to read data from the restricted access region only after certificate information given to the nonvolatile memory device is authenticated. Unauthorized reading from the restricted access region can be protected.

[26] When the data processing system includes a host interface control circuit, if copyright should be taken into consideration, the host interface control unit preferably can output certificate information retrieved from the storage medium to a host device in order to receive a contents information license including a contents key that is used to decrypt the contents information.

[27] If the above certificate information sent to the host is authenticated there, it is preferable that the host interface control circuit receives the contents information license from the host device and can store the contents information license into the storage medium.

[28] It is preferable that the host interface control circuit can store time information that is input with the contents key into the storage medium as an initial value of the access time stamp information. Such time information is obtained with a very low possibility of being tampered with.

Download Terminal Device

In the third facet of the present invention, a data processing system such as a download terminal device supports the function to prevent fraudulent access to data whose usage is restricted to a time limit.

[29] A data processing system according to the present invention comprises a host interface unit, a storage medium interface unit, and a data processing unit and stores certain information into a storage medium installed in the storage medium interface unit. The data processing unit outputs a request to deliver a decryption key and certificate information retrieved from the storage medium to the outside through the host interface unit, receives information returned in response to the request through the host interface unit, and, based on the received information, stores the decryption key to decrypt contents information provided by web-based rental service and restriction information to restrict access to the contents information as the certain information into the storage medium through the storage medium interface unit. The restriction information includes access time limit information and access time stamp information. An initial value of the access time stamp information is time information included in the received information. The certificate information comprises information indicating the storage medium with a particular feature. The storage medium with a particular feature comprises a control circuit and a nonvolatile memory circuit and the nonvolatile memory circuit includes a storage region for the restriction information. The control circuit performs an access decision action which comprises deciding whether access to the contents information is enabled or disabled, based on real time information which is supplied externally and the restriction information, and updating the access time stamp information to the real time information. The control circuit decides that access is disabled in the case where the real time information is later than the access time limit given by the access time limit information or in the case where the real time information is earlier than the access time stamp given by the access time stamp information, and in the case other than these cases, the control circuit decides that the access is enabled. The control circuit performs the access decision action, at least, at the start of access to the contents information and at the end of the access.

Distribution Terminal Device

In the fourth facet of the present invention, a data processing system such as a distribution terminal device supports the function to prevent fraudulent access to data whose usage is restricted to a time limit.

[30] A data processing system according to the present invention comprises a storage medium interface unit and a data processing unit and stores certain information into a storage medium installed in the storage medium interface unit. The data processing unit retrieves certificate information from the storage medium in response to a request to issue a decryption key, authenticates the storage medium, and stores the decryption key to decrypt contents information provided by web-based rental service and restriction information to restrict access to the contents information as the certain information into the storage medium through the storage medium interface unit. The restriction information includes access time limit information and access time stamp information and an initial value of the access time stamp information is time information relevant to the contents distribution. The certificate information comprises information indicating the storage medium with a particular feature. The storage medium with a particular feature is the same as the storage medium recited in the foregoing item (29).

### BRIEF DESCRIPTION OF THE DRAWINGS

FIG. 1 is a block diagram of a contents data distribution system to which the present invention is applied;

FIG. 2 is a schematic diagram showing an example of embodiment where a data terminal device configured in another way than the corresponding device shown in FIG. 1 is connected to the contents data distribution system to which the present invention is applied;

FIG. 3 illustrates the overview of contents usage restriction by the time data retained on the card, wherein the time data is updated to the terminal internal time data;

FIG. 4 is a block diagram showing a configuration example of a within/out-of-time-limit decision unit with a terminal internal clock, shown in FIG. 1;

FIG. 5 illustrates an example of a time data format;

FIG. 6 is a block diagram showing a configuration example of a within/out-of-time-limit decision unit integrated into a memory card shown in FIG. 2;

FIG. 7 illustrates an example of a playback license format;

FIG. 8 illustrates an example of a secure license format;

FIG. 9 is a flowchart illustrating a procedure of authentication (for write access) when writing licenses;

FIG. 10 is a flowchart illustrating a procedure of authentication (for read access) when reading the licenses;

FIG. 11 is a flowchart illustrating a process example of playback of contents with a usable time limit;

FIG. 12 is a flowchart illustrating an example of a detailed process of deciding whether it is within or out of usable time limit, included in the flowchart of FIG. 11;

FIG. 13 is a flowchart illustrating an example of a detailed process of updating the time data retained on the card, included in the flowchart of FIG. 11;

FIG. 14 is a block diagram showing an example of a playback terminal device for data with a usable time limit; and

FIG. 15 is a block diagram showing an example of a download terminal device.

### DETAILED DESCRIPTION OF THE PREFERRED EMBODIMENTS

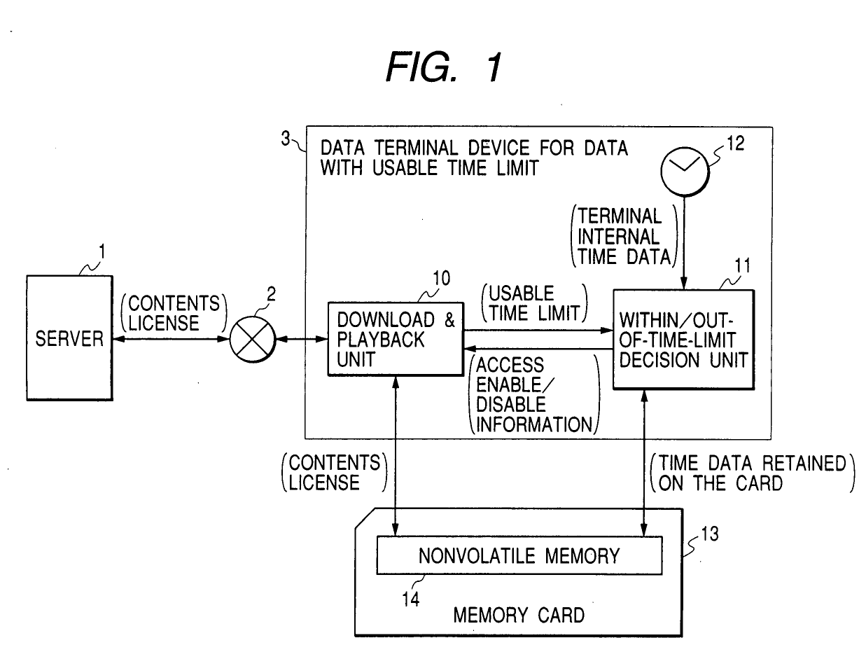

FIG. 1 shows an example of a contents data distribution system according to an embodiment of the preset invention. To a network 2 to which a contents server 1 connects, a representative data terminal device (data processing device) for data with a usable time limit 3 is connected. The data terminal device for data with a usable time limit (also referred to as simply the data terminal device) 3 comprises a download and playback unit (consisting of a download block and a playback block) 10, a within/out-of-time-limit decision unit (usage restriction unit) 11, and a terminal internal clock 12. A nonvolatile memory device (also referred to as simply a memory card) 13, as a storage medium, can be installed in and removed from the data terminal device 3 at will. The memory card 13 comprises a nonvolatile memory (nonvolatile memory circuit) such as a flash memory and data can electrically be erased from and written to the nonvolatile memory.

A contents data download function of the data terminal device 3 will be summarized. When the memory card 13 is installed in the data terminal device 3 and a command to download contents data is issued to the data terminal device 3, the data terminal device 3 requests the contents server 1 to download the contents data with a usable time limit (contents information provided by web-based rental service) and its playback license (the license of the contents information). After the contents data and its playback license are downloaded from the contents server 1, the data terminal device 3 writes them into the memory card 13. At this time, the data terminal device 3 receives time data corresponding to the date and time of the download as well and writes the time data into the memory card 13. The time data written into the memory card 13 is the time data retained on the card. Preferably, the downloaded time data is framed into a license format in the within/out-of-time-limit decision unit and stored as a secure license into a secure region of the nonvolatile memory 14, but the embodiment is not so limited. The usable time limit is also included in the secure license, but the embodiment is not so limited. The playback license is also stored into the secure region of the nonvolatile memory 14, but the embodiment is not so limited.

A playback function of the data terminal device 3 to play back the contents data with a usable time limit will be summarized. When a command to play back the contents is issued to the data terminal device 3, the data terminal device 3 reads the playback license of the contents from the memory card 13. The usable time limit is retrieved from the playback license and passed to the within/out-of-time-limit decision unit 11. The within/out-of-time-limit decision unit 11 decides whether access to the contents is enabled or disabled, according to the usable time limit of the contents data (access time limit information), terminal internal time data (real time information) provided by the terminal internal clock 12, time data retained on the card (access time stamp information). Specifically, if the time given by the terminal internal time data is later than the access time limit given by the access time limit information or if the time given by the terminal internal time data is earlier than the time given by the time data retained on the card, the within/out-of-time-limit decision unit 11 decides that the access is disabled; otherwise, the decision unit 11 decides that the access is enabled. If the access is enabled, the contents data is read from the memory card 13 and played back. If the access is disabled, the playback license and other data of the contents are erased. The within/out-of-time-limit decision unit 11 updates the time data retained on the memory card 13, according to the terminal internal time data, simultaneously with deciding whether the access is enabled or disabled.

Updating the time data retained on the card is performed not only at the start of access to the contents, normally, when the decision unit decides whether the access is enabled or disabled, but also at the end of the access. Moreover, this update may preferably be performed, for example, at least, when the operating power supply to the memory card is turned on and when the operating power supply is turned off.

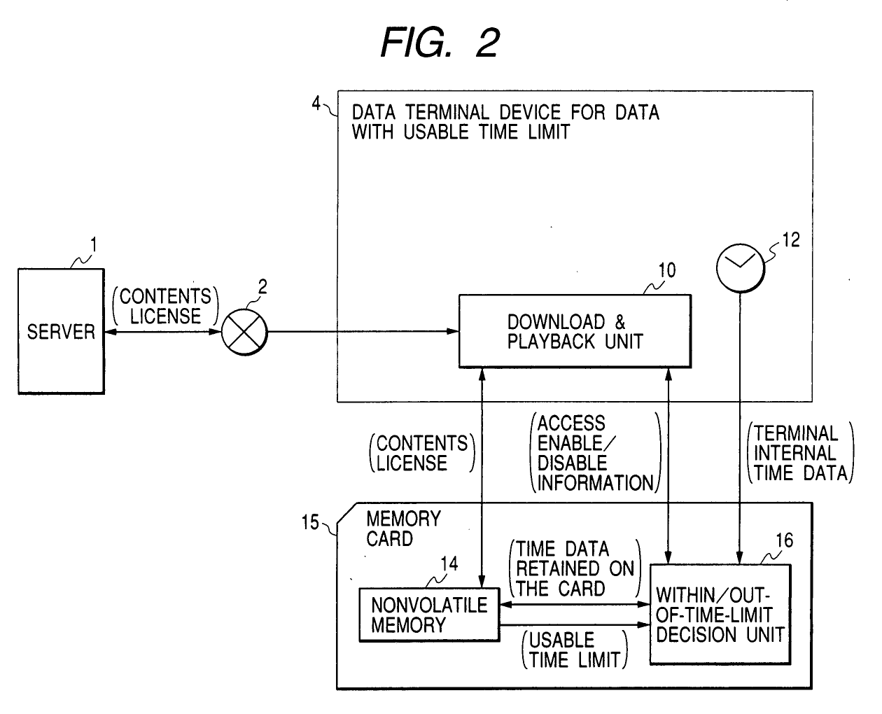

FIG. 2 shows an example of embodiment where a data terminal device 4 configured in another way than the corresponding device shown in FIG. 1 is connected to the contents data distribution system. The data terminal device 4 comprises the download and playback unit (consisting of a download block and a playback block) 10 and the terminal internal clock 12. A nonvolatile memory device (also referred to as simply a memory card) 15, as the storage medium, can be installed in and removed from the data terminal device 4 at will. The memory card 15 comprises a within/out-of-time-limit decision unit (usage restriction unit) 16 and the nonvolatile memory 14.

The contents data download function of the data terminal device 4 will be summarized. When the memory card 14 is installed in the data terminal device 4 and the command to download contents data is issued to the data terminal device 4, the data terminal device 4 requests the contents server 1 to download the contents data with a usable time limit (contents information provided by web-based rental service) and its playback license (the license of the contents information). After the contents data and its playback license are downloaded from the contents server 1, the data terminal device 4 writes them into the memory card 15. At this time, the data terminal device 3 receives time data corresponding to the date and time of the download as well and writes the time data into the memory card 15. The time data written into the memory card 15 is the time data retained on the card. Preferably, the downloaded time data is framed into the license format in the within/out-of-time-limit decision unit and stored as the secure license into the secure region of the nonvolatile memory 14, but the embodiment is not so limited. The playback license is also stored into the secure region of the nonvolatile memory 14, but the embodiment is not so limited.

The playback function to play back contents data with a usable time limit will be summarized. When the command to play back the contents is issued to the data terminal device 4, the data terminal device 4 signals the within/out-of-time-limit decision unit 16 to retrieve the playback license of the contents from the memory card 14. The within/out-of-time-limit decision unit 16 reads the playback license and retrieves the usable time limit therefrom. The within/out-of-time-limit decision unit 16 decides whether the access to the contents is enabled or disabled, according to the usable time limit of the contents data (access time limit information), terminal internal time data (real time information) provided by the terminal internal clock 12, time data retained on the card (access time stamp information) that the nonvolatile memory 14 holds. Specifically, if the time given by the terminal internal time data is later than the access time limit given by the access time limit information or if the time given by the terminal internal time data is earlier than the time given by the time data retained on the card, the within/out-of-time-limit decision unit 16 decides that the access is disabled; otherwise, the decision unit 16 decides that the access is enabled. If the access is enabled, the within/out-of-time-limit decision unit 16 signals the download and playback unit 10 to read the contents data from the memory card 13 and the contents can be played back. The within/out-of-time-limit decision unit 16 updates the time data retained on the memory card, according to the terminal internal time data, simultaneously with deciding whether the access is enabled or disabled.

Updating the time data retained on the card is performed not only at the start of access to the contents, normally, when the decision unit decides whether the access is enabled or disabled, but also at the end of the access. Moreover, this update may preferably be performed, for example, at least, when the operating power supply to the memory card is turned on and when the operating power supply is turned off.

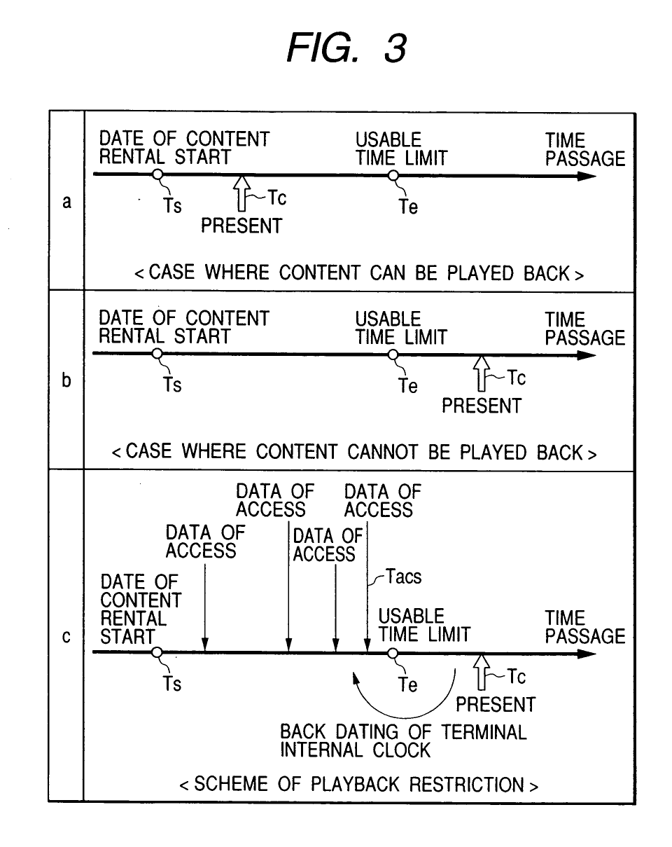

FIG. 3 illustrates the overview of contents usage restriction by the time data retained on the card, wherein the time data is updated to the terminal internal time data. The date and time at which contents data was downloaded (the date of contents rental start) Ts and the usable time limit (the date of return) Te are fixed. The “present” point of time corresponds to the time Tc given by the terminal internal time data. The “date of access” corresponds to the time Tacs given by the time data retained on the card. Unless the time data retained on the card is updated, the time given by it is fixed to the date and time at which contents data was downloaded (the date of contents rental start). If the time data retained on the card Tacs is not updated as in the case of (a), the contents can be played back when the present time Tc is any point of time between the date of contents rental start Ts and the usable time limit Te. For example, as in the case of (b), if the present time Tc is past the usable time limit Te, the contents cannot be played back. However, if the user shifts the present time to any point between the date of contents rental start Ts and the usable time limit Te by manipulating the terminal clock, the contents data can be played back fraudulently. To prevent this, the time data retained on the memory card is updated to the terminal internal time data every time access to the contents data occurs, as described for the embodiments of the present invention shown in FIGS. 1 and 2. Thus, as illustrated in (c), each time the time data retained on the card Tacs is updated at each point of time corresponding to “date of access,” the interval between the time given by the time data and the usable time limit becomes shorter and eventually the time goes beyond the usable time limit Te. Once it goes beyond the time limit, it is impossible to access the contents. Even if the user backdates the terminal internal clock to date and time prior to the usable time limit, it is no longer allowed to play back the contents. Consequently, a fraudulent playback of contents whose usage is restricted to a time limit can be well prevented even if such a fraudulent playback is attempted by manipulating the internal clock of the data terminal device.

Because the time data retained on the card is updated not only at the timing of the end of access to the contents, but also at the timing of the start of the access, it is ensured that access time stamp information is updated at least once per access even if the power supply is turned off immediately before the termination of a playback of the contents information. Because the nonvolatile memory device (card) is provided with the function to prevent fraudulent access to the contents information with a usable time limit in the embodiment shown in FIG. 2, it is easy to keep the function to prevent fraudulent access still working even after the playback device is replaced.

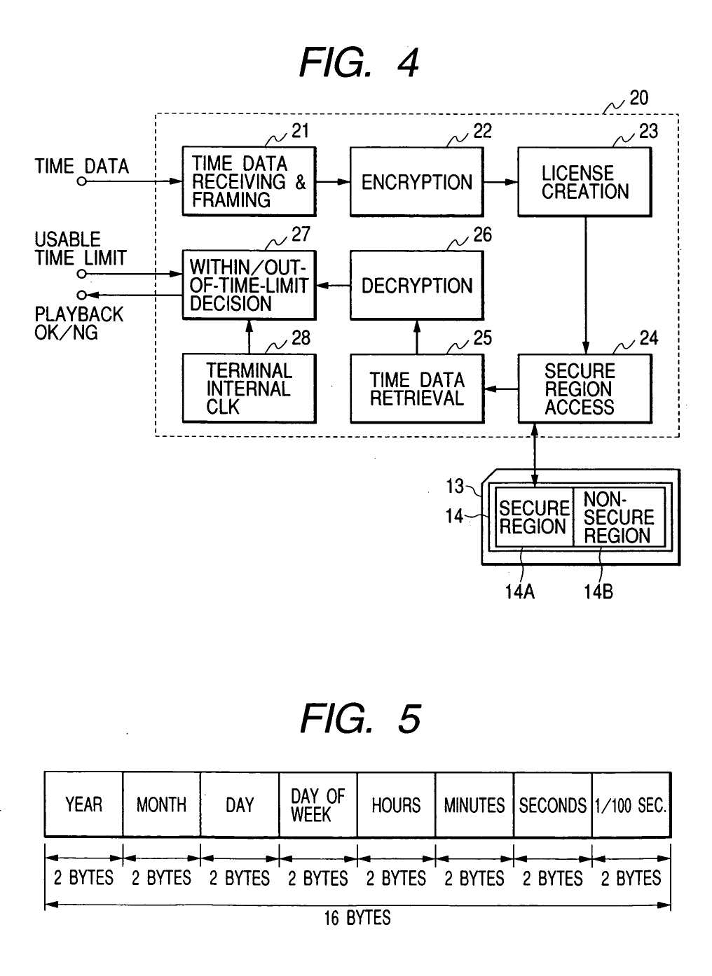

FIG. 4 shows a configuration example of the within/out-of-time-limit decision unit 11 with the terminal internal clock 12. A circuitry block 20 can be constructed as a microcomputer which embodies at least the within/out-of-time-limit decision unit 11 with the terminal internal clock 12. FIG. 4 shows functional blocks internal to the microcomputer 20. The microcomputer 20 comprises a time data receiving and framing block 21, an encryption block 22, a license creation block 23, a secure region access block 24, a time data retrieval block 25, a decryption block 26, a within/out-of-time-limit decision block 27, and a terminal internal clock circuit 28.

The nonvolatile memory 14 comprises a secure region (restricted access region) 14A and a non-secure region (unrestricted access region) 14B. Write access to the secure region 14A is allowed only after certificate information held within the memory card 13 is authenticated by the appropriate entity external to the memory card, for example, the terminal device 3 or the server 1. Read access to the secure region 14A from the external is allowed only if certificate information given from the external is authenticated. The memory card 13 includes a card controller which is not shown. The card controller controls interfacing of the access control of the nonvolatile memory 14 with the external. The secure region access block 24 interfaces with the memory card via the card controller.

In this example, after the time data to be retained on the card is encrypted by the encryption block 22, the license creation block 23 embeds the thus encrypted time data into a secure license and the secure license is stored into the secure region 14A of the nonvolatile memory 14 under the control of the secure region access block 24.

The time data receiving and framing block 21 is a circuit that receives time data (date and time of a download) from the server 1 when the server 1 downloads contents data and its license to the terminal device. The received time data is framed into a 16-byte data format which is illustrated in FIG. 5.

The encryption block 22 encrypts the time data received from the server. Preferably, the time data is encrypted by Advanced Encryption Standard (AES) on the assumption that contents are encrypted and decrypted by the AES, but cryptography applicable to this invention is not limited to the AES. For a time data encryption key, attribute information unique to the memory card, for example, the card serial number can be used.

The license creation block 23 embeds the received and encrypted time data into, for example, a contents key portion of a license format, thus creating a secure license.

The secure region access block 24 writes the secure license including the time data into the secure region 14A of the nonvolatile memory. To write the license into the secure region 14A, authentication for write access is necessary, as noted above. The time data retrieval block 25 reads the license including the encrypted time data from the secure region and retrieves the encrypted time data. To read the license from the secure region 14A, authentication for read access is necessary, as noted above.

The decryption block 26 decrypts the encrypted time data retrieved from the secure license by the AES. For a decryption key, the same key as used by the encryption block 22 is used.

The within/out-of-time-limit decision block 27 decides whether the usable time limit of the contents expires and detects whether the terminal internal clock has been manipulated by the user, as described above. The detail of this decision has already been described with reference to FIG. 1. If it is detected that the clock has been manipulated, all licenses related to the contents data are erased from the card. The terminal internal clock circuit 28 obtains real time from the terminal internal clock.

The functional blocks shown in FIG. 4 can be constructed in arrangement comprising a central processing unit, floating-point arithmetic units, ROMs (read only memories) which store processing programs for these units, RAMs (random access memories) which are used for working areas for the CPU and other purposes, a real-time clock circuit, timers, input/output circuits, etc., but these entities are not shown.

The operation of the circuitry of FIG. 4 will be described. The operation during communication with the server 1 and during the download of contents and license is first described.

During connection with the server 1, the time data receiving and framing block 21 receives the time data of the download from the server 1. The received time data is framed into, for example, the 16-byte data format illustrated in FIG. 5, so that the time data can be embedded into the contents key region of the license format. If the date and time of the download is 2002/10/10 (Thursday) at 15:30:45:00, this time data is represented in hexadecimal notation as “07D2 000A 000A 0004 000F 001E 002D 0000 h”.

The encryption block 22 encrypts the 16-byte time data frame generated by the time data receiving and framing block 21 by the AES. For the encryption key, the serial number unique to the card is used.

The license creation block 23 embeds the encrypted time data into the contents key portion of the license format and creates one license. The secure region access block 24 writes the created license into the secure region of the memory card. If the secure region is capable of storing 128 licenses, the license including the time data is written in the last 128th position. Writing of the license into the secure region 14A is allowed only after authentication for write access is accepted, as noted above.

Next, the operation for within/out-of-time-limit decision is described. The secure region access block 24 reads the secure license including the encrypted time data from the secure region 14A. Read access to the secure region is allowed only after authentication for read access is accepted, as noted above. The time data retrieval block 25 retrieves the encrypted 16-byte time data from the license. The decryption block 26 decrypts the 16-byte time data by the AES. For the decryption key, the same serial number unique to the card as used for encryption is used. Then, the terminal internal clock circuit 28 obtains real time internal to the terminal. Using the usable time limit, terminal internal time data, time data retained on the card, the within/out-of-time-limit decision block 27 decides whether the time limit of the contents data expires and detects whether the clock has been manipulated fraudulently.

Next, the operation for updating the time data is described. Because the card has no internal power supply, the card cannot update the time data by itself. Thus, the time data retained on the card is updated when the terminal makes the connection to the server and when the contents are played back and rendered (if the playback is enabled by within/out-of-time-limit decision), as described above. However, unless the terminal makes the connection to the server and unless the contents are played back and rendered, the time data retained on the card may remain not updated for a long time. In addition to updating the time data at the start and the end of each access to the contents as described above, it is preferable to update the time data when the memory card is inserted into the data terminal and when the card is removed from the data terminal, or when a power-on command is issued to the data terminal with the memory card installed in the data terminal and when a power-off command is issued to the data terminal. When the power supply to the data terminal is turned off, this update can be performed by adding the time measured by a timer internal to the microcomputer to the time data recorded on the card.

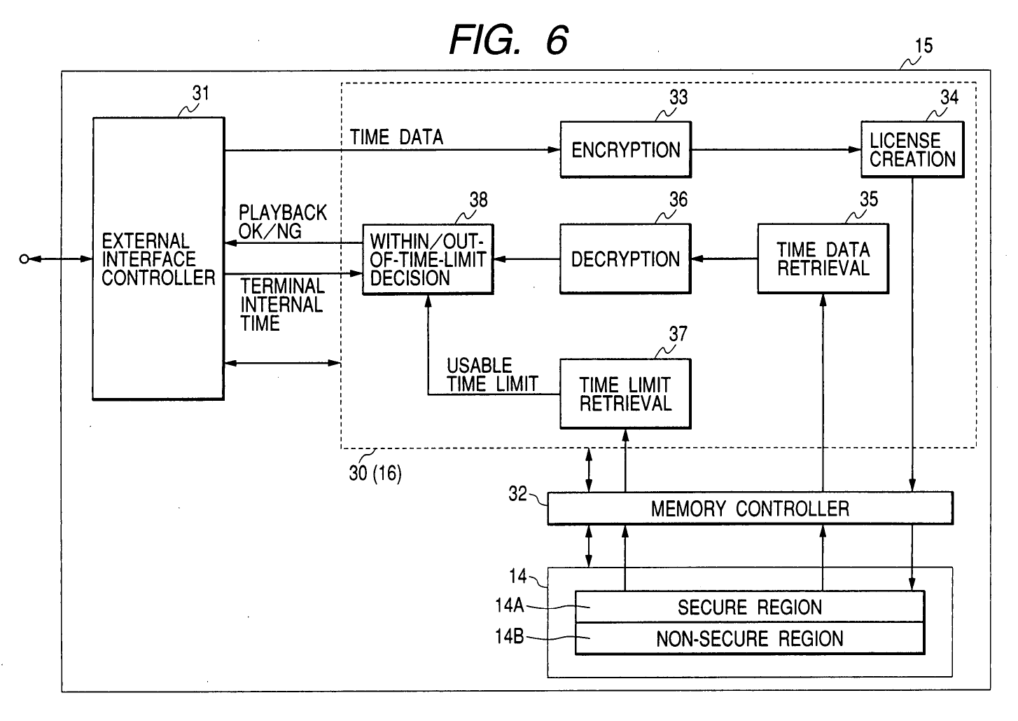

FIG. 6 shows a configuration example of the within/out-of-time-limit decision unit 16 integrated into the memory card 15. The within/out-of-time-limit decision unit 16 is constructed with a microcomputer 30. In FIG. 6, the microcomputer 30, an external interface controller 31, and a memory controller 32 constitute a card controller. Functional blocks constituting the within/out-of-time-limit decision unit 16 which is a part of the functionality of the microcomputer 30 are shown in FIG. 6. The functional blocks shown, which are realized by the microcomputer 30, are an encryption block 33, a license creation block 34, a time data retrieval block 35, a decryption block 36, a time limit retrieval block 37, and a within/out-of-time-limit decision block 38.

The external interface controller 31 performs external interface control in accordance with predefined memory card interface specifications at the command of the microcomputer 30. The memory controller 32 performs access control to erase data from, write data to, and read data from the nonvolatile memory 14 at the command of the microcomputer 30.

The microcomputer 30 is comprised of a central processing unit, floating-point arithmetic units, ROMs (read only memories) which store processing programs for these units, RAMs (random access memories) which are used for working areas for the CPU and other purposes, a real-time clock circuit, timers, input/output circuits, etc., but these entities are not shown. In addition to realizing the functions of the within/out-of-time-limit decision unit 16, the microcomputer 30 has functions to execute computation for authentication and to perform address processing for accessing the nonvolatile memory 14 in accordance with its operation program.

The nonvolatile memory 14 comprises the secure region (restricted access region) 14A and the non-secure region (unrestricted access region) 14B. Write access to the secure region 14A is allowed only after certificate information held within the memory card 15 is authenticated by the appropriate entity external to the memory card, for example, the terminal device 4 or the server 1. Read access to the secure region 14A from the external is allowed only if certificate information given from the external is authenticated. The certificate information held within the memory card 15 includes information that indicates that the memory card is provided with the within/out-of-time-limit decision function described with reference to FIGS. 2 and 6 and makes the memory card distinguishable from other memory cards.

In this example, after the time data to be retained on the card is encrypted by the encryption block 33, the license creation block 34 embeds the thus encrypted time data into a secure license and the secure license is stored into the secure region 14A of the nonvolatile memory 14 via the memory controller 32. The usable time limit of the contents is also included in the secure license, but the embodiment is not so limited.

When the download and playback unit 10 shown in FIG. 2 receives contents data and its license downloaded from the server, it also receives time data (date and time of the download) from the server 1. The time data is attached to the contents license. The received time data is framed into the 16-byte data format illustrated in FIG. 5.

The encryption block 33 receives and encrypts the time data received from the server. Preferably, the time data is encrypted by the AES on the assumption that contents are encrypted and decrypted by the AES, but cryptography applicable to this invention is not limited to the AES. For the time data encryption key, attribute information unique to the memory card, for example, the card serial number can be used.

The license creation block 34 embeds the received and encrypted time data into, for example, the contents key portion of the license format, thus creating a secure license.

The created secure license is written into the secure region 14A of the nonvolatile memory via the memory controller 32. To write the license into the secure region 14A, authentication for write access is necessary, as noted above. When the secure license including the encrypted time data is read from the secure region 14A, the time data retrieval block 35 retrieves the encrypted time data from the license. When the secure license is read from the secure region 14A, the time limit retrieval block 37 retrieves the usable time limit data from the license. To read the license from the secure region 14A, authentication for read access is necessary, as noted above.

The decryption block 36 decrypts the encrypted time data retrieved from the secure license by the AES. For the decryption key, the same key as used by the encryption block 33 is used.

The within/out-of-time-limit decision block 38 decides whether the usable time limit of the contents expires and detects whether the clock 12 internal to the data terminal 4 has been manipulated by the user, as described above. The detail of this decision has already been described with reference to FIG. 2. If it is detected that the clock has been manipulated, all licenses related to the contents data are erased from the secure region 14A.

The operation of the circuitry of FIG. 6 will be described. The operation during communication with the server 1 and during the download of contents and license is first described.

When the data terminal device 4 makes the connection to the server 1, the time data of the download from the server 1 is input through the external interface controller 31. Also, the playback time limit data is input. The playback time limit is, for example, derived from the playback license. The input time data is framed into the 16-byte data format illustrated in FIG. 5. The time data is encrypted by the encryption block 33, for example, by the AES. For the encryption key, the serial number unique to the card is used.

The license creation block 34 embeds the encrypted time data into the contents key portion of the license format and creates a secure license. The created license is written into the secure region 14A of the memory card 14 via the memory controller 32. If the secure region is capable of storing 128 licenses, the above secure license is written in the last 128th position. Writing of the license into the secure region 14A is allowed only after authentication for write access is accepted, as noted above.

Next, the operation for within/out-of-time-limit decision is described. The secure license is read from the secure region 14A via the memory controller 32. Read access to the secure region is allowed only after authentication for read access is accepted, as noted above. The time data retrieval block 35 retrieves the encrypted 16-byte time data from the license. The time limit retrieval block 37 retrieves the usable time limit from the license. The decryption block 36 decrypts the 16-byte time data by the AES. For the decryption key, the same serial number unique to the card as used for encryption is used. Then, real time internal to the terminal is obtained. Using the usable time limit, terminal internal time data, time data retained on the card, the within/out-of-time-limit decision block 38 decides whether the time limit of the contents data expires and detects whether the clock has been manipulated fraudulently.

Next, the operation for updating the time data is described. Because the card has no internal power supply, the card cannot update the time data by itself. Thus, the time data retained on the card is updated when the terminal makes the connection to the server and when the contents are played back and rendered (if the playback is enabled by within/out-of-time-limit decision), as described above. However, unless the terminal makes the connection to the server and unless the contents are played back and rendered, the time data retained on the card may remain not updated for a long time. In addition to updating the time data at the start and the end of each access to the contents as described above, it is preferable to update the time data when the memory card is inserted into the data terminal and when the card is removed from the data terminal, or when the power-on command is issued to the data terminal with the memory card installed in the data terminal and when the power-off command is issued to the data terminal. When the power supply to the data terminal is turned off, this update can be performed by adding the time measured by the timer internal to the microcomputer to the time data recorded on the card.

It may also preferable to update the time data at yet another timing. If the memory card allows files that respectively store the divisions of contents data to be accessed in units of sectors, after the above-described access decision action decides that initial access to one of the divisions is enabled, the access decision action may be performed each time accessing each of or a given number of the remaining divisions of the contents data stored in subsequent sectors. The access decision action that is thus performed when accessing the data divisions stored in the sectors may preferably be programmed such that the access decision action for access to the second and subsequent divisions of the contents data decides that access is enabled even if the real time information is later than the access time limit given by the access time limit information. This can simply eliminate the following inconvenience for the user: as the access decision action is repeated when accessing the divisions of contents data, the time limit comes during the playback of the contents information and the playback is stopped.

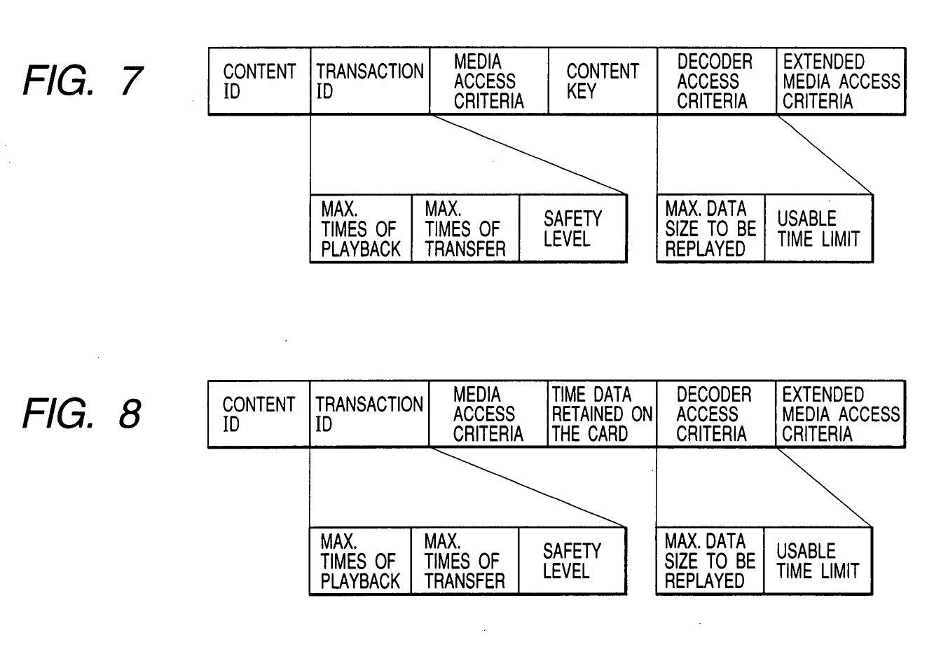

FIG. 7 illustrates an example of a playback license format. FIG. 8 illustrates an example of a secure license format. Contents ID is an identifier uniquely assigned to an individual item of contents. Transaction ID is an identifier uniquely assigned to an individual transaction. The transaction ID field comprises the following subfields: maximum times of playback (the maximum number of times the license can be read), maximum times of transfer (the maximum number of times the license can be transferred), and safety level (the level of protection strength). Media access criteria are access criteria that can be forcibly applied within the media. Contents key is a key that was used to encrypt the contents and is also used decrypt the contents. Decoder access criteria are access criteria that can be forcibly applied within the decoder for playback. The decoder access criteria field comprises the following subfields: maximum data size to be replayed (the maximum contents data size that can be replayed by one license) and usable time limit (time limit by which the contents can be played back). Extended media access criteria are flags indicating whether certificate authentication is performed and indicating whether PIN authentication is performed. The playback license includes the contents key, whereas the secure license includes the time data retained on the card instead of the contents key.

Certificate information for certificate authentication, for example, authentication for write access to the secure region, and Personal Identification Number (PIN) for personal authentication are stored in the nonvolatile memory 14.

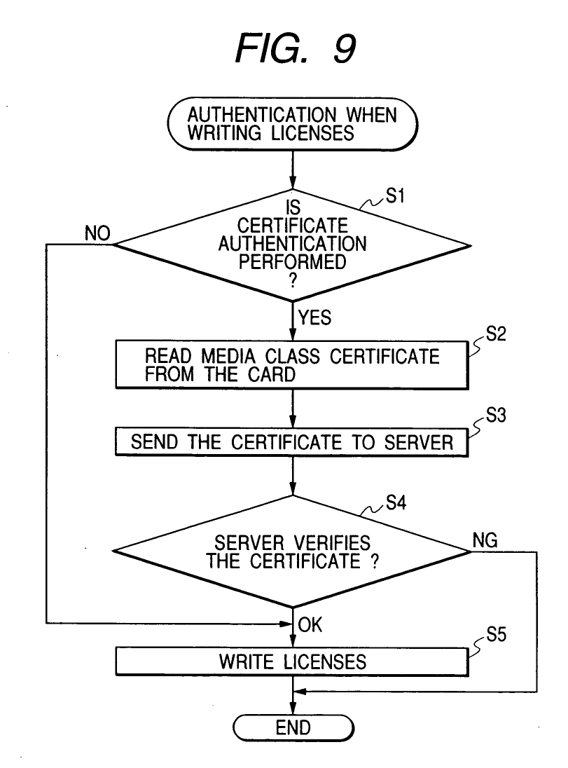

FIG. 9 illustrates a procedure of authentication (for write access) when writing licenses. First, it is decided whether certificate authentication is performed (S1). If certificate authentication is performed, a certificate (media class certificate) having authentication information and a public encryption key is read from the memory card (S2) and the certificate is sent to the server (S3) The server verifies the certificate (S4). As a result, if authentication is successful, writing of the playback license and secure license into the secure region of the memory card is allowed (S5). The media class certificate includes certificate information, for example, information that makes the memory card 15 provided with the within/out-of-time-limit decision function distinguishable from other memory cards that are not provided with the above function.

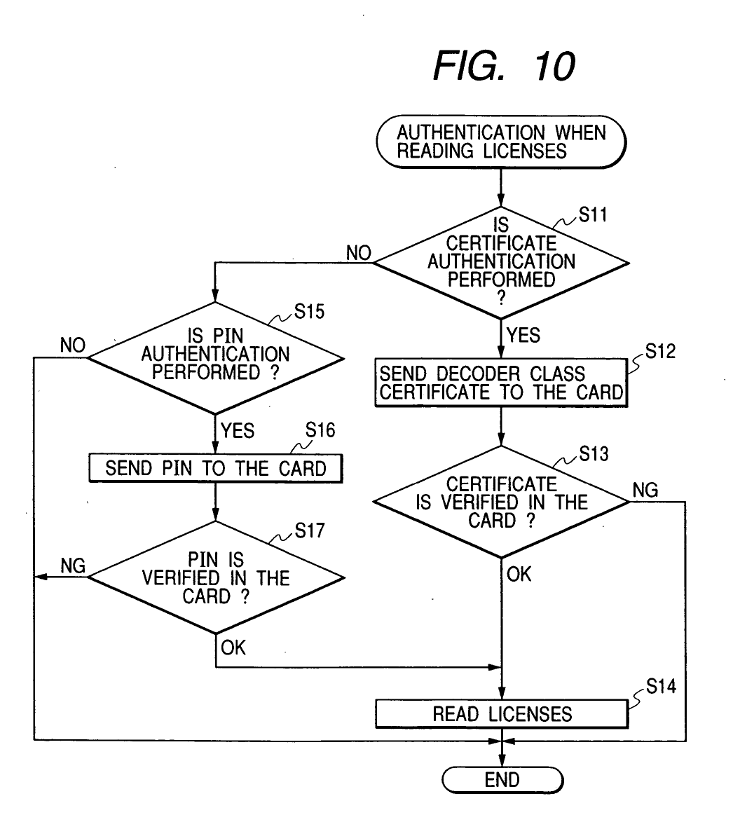

FIG. 10 illustrates a procedure of authentication (for read access) when reading the licenses. First, it is decided whether certificate authentication is performed (S11). If certificate authentication is performed, a certificate (decoder class certificate) having authentication information and a public encryption key is sent from the data terminal to the memory card (S12). The memory card verifies the certificate (S13). As a result, if authentication is successful, reading of the playback license and secure license from the secure region of the memory card is allowed (S14). If it is decided that certificate authentication is not performed in the decision step S11, it is decided whether PIN authentication is performed (S15). If PIN authentication is performed, PIN is sent from the data terminal device to the memory card (S16) and the PIN is verified in the memory card. If the PIN is valid, reading of the licenses is performed (S14). If the PIN is invalid, if the PIN authentication is not performed, or if certificate authentication cannot be obtained, the procedure terminates immediately.

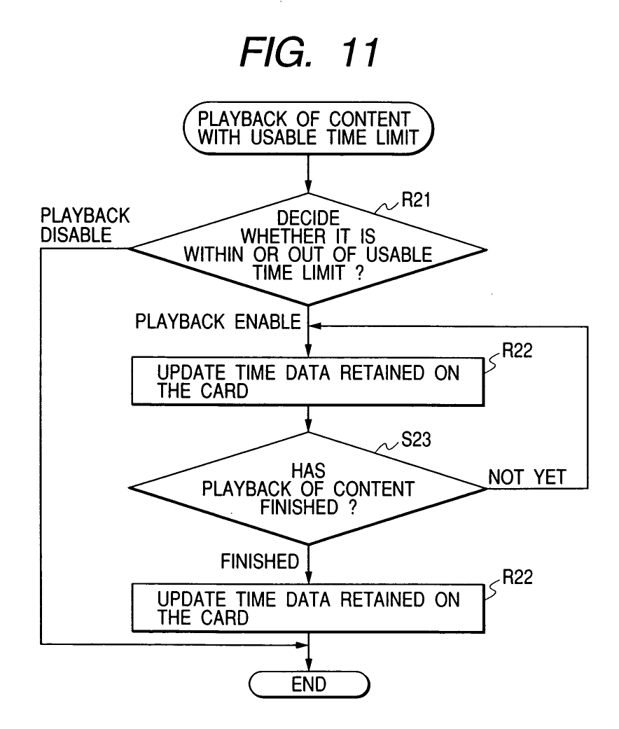

FIG. 11 illustrates a process flow example of playback of contents with a usable time limit. Prior to playing back contents with a usable time limit, using the playback license, a step of deciding whether it is within or out of usable time limit R21 is first performed. If playback is enabled, a step of updating the time data retained on the card R22 is performed and the contents are played back. It is decided whether the playback of the contents has finished (S23). If not, the step of updating the time data retained on the card R22 is repeated at predetermined intervals. When the playback has finished, finally, the step of updating the time data retained on the card R22 is performed again and the process terminates.

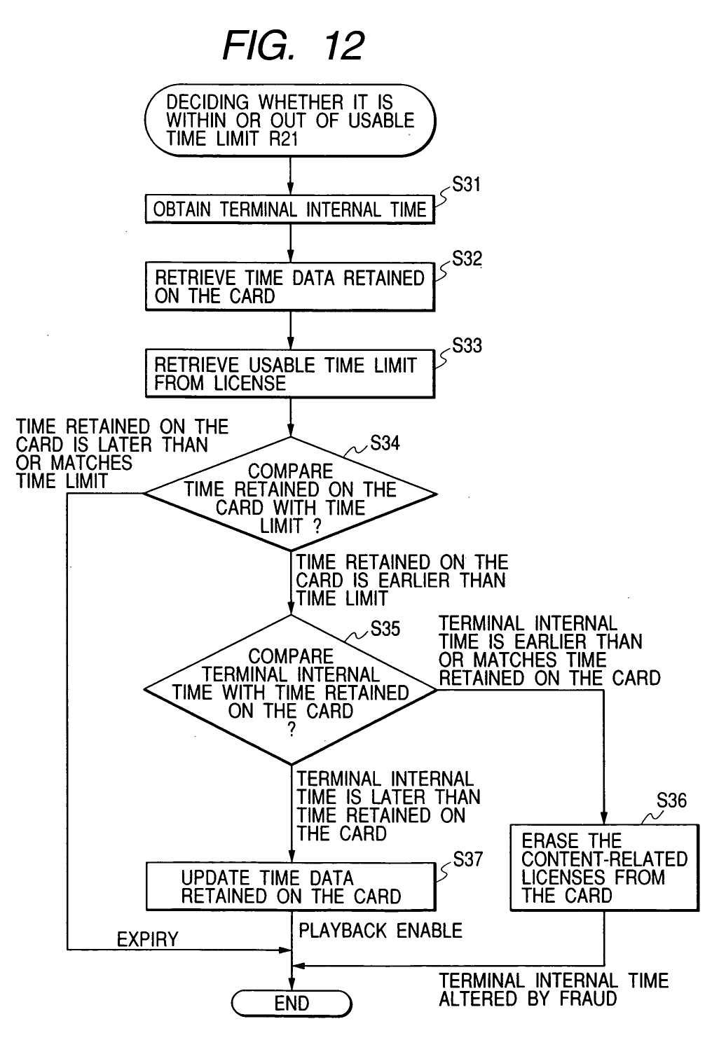

FIG. 12 illustrates an example of a detailed process of deciding whether it is within or out of usable time limit R21. Time information internal to the data terminal device is obtained and terminal internal time data is generated (S31) After necessary certificate authentication or PIN authentication is performed, the time data retained on the card is retrieved from the memory card (S32). The usable time limit is retrieved from the license (S33). The time data retained on the card is compared with the usable time limit (S34). If the time retained on the card is later than or matches the time limit, it is decided that the time limit expires and the process terminates. If the time retained on the card is earlier than the time limit, the terminal internal time data is compared with the time data retained on the card (S35). If the terminal internal time is earlier than or matches the time retained on the card, it is decided that the terminal internal time data has been altered by fraud and all the contents-related licenses held on the memory card are erased from the card (S36). If the terminal internal time is later than the time retained on the card, the time data retained on the card is updated to the terminal internal time data (S37).

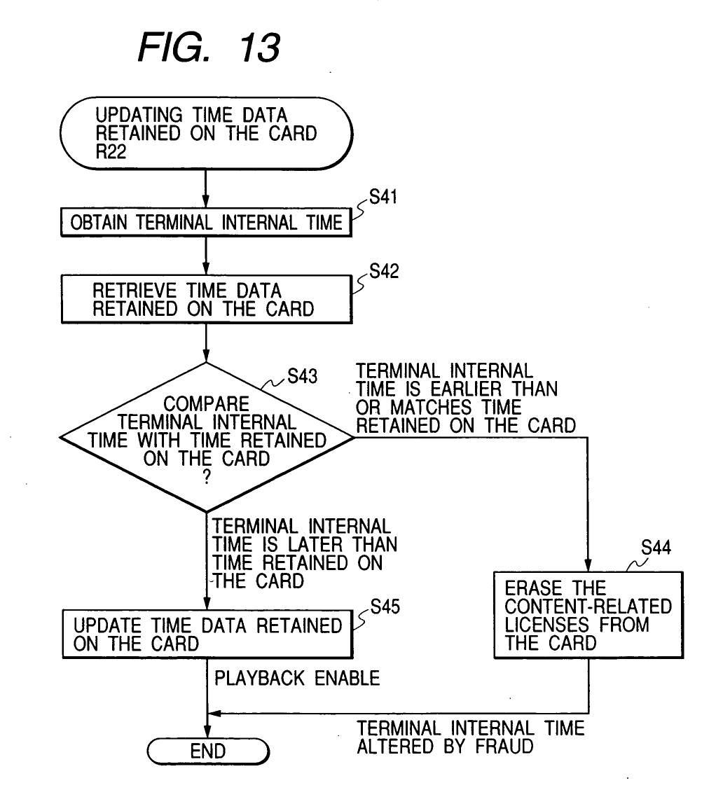

FIG. 13 illustrates an example of a detailed process of updating the time data retained on the card R22. Time information internal to the data terminal device is obtained and terminal internal time data is generated (S41). After necessary certificate authentication or PIN authentication is performed, the time data retained on the card is retrieved from the memory card (S42). The terminal internal time data is compared with the time data retained on the card (S43). If the terminal internal time is earlier than or matches the time retained on the card, it is decided that the terminal internal time data has been altered by fraud and all the contents-related licenses held on the memory card are erased from the card (S44). If the terminal internal time is later than the time retained on the card, the time data retained on the card is updated to the terminal internal time data (S45). Unlike the process of FIG. 12, in the process of FIG. 13, the usable time limit is not retrieved from the license and the following is not performed: if the time retained on the card is later than or matches the time limit, it is decided that the time limit expires and the process terminates. Thus, the process of FIG. 13 can eliminate the inconvenience that the time limit comes during the playback of the contents with the usable time limit and the playback is stopped.

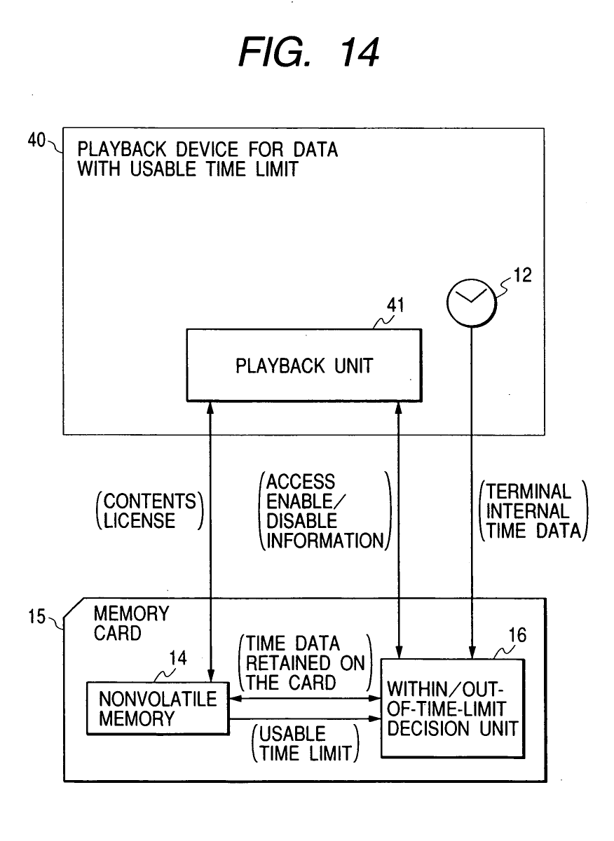

FIG. 14 shows a playback terminal device 40 for data with a usable time limit. The playback terminal device 40 shown in FIG. 14 comprises a playback unit 41 and is configured as a playback-dedicated device, dispensing with the function of downloading contents data and license, which is a dissimilarity from the terminal device 4 shown in FIG. 2. This device is capable of performing contents playback and related processes illustrated in FIG. 11 through FIG. 13.

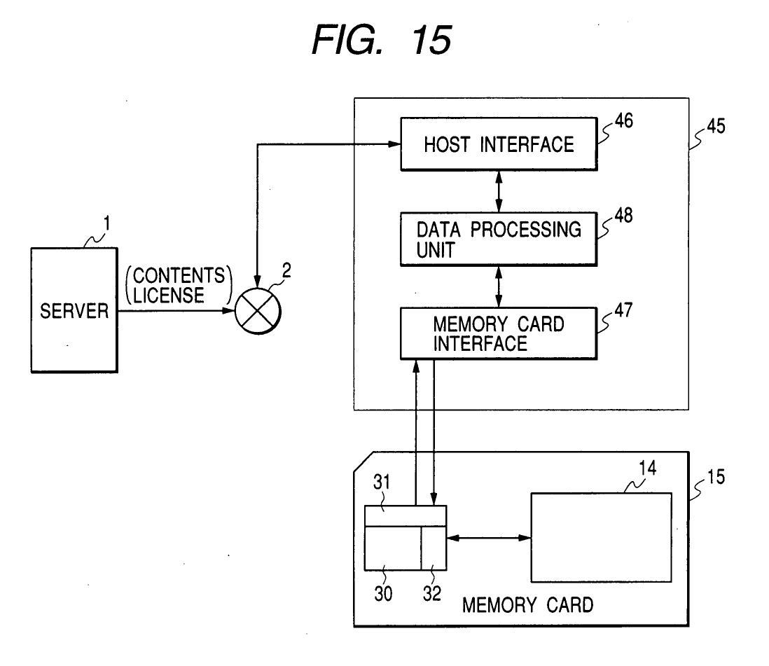

FIG. 15 shows a download terminal device 45. The download terminal device 45 shown in FIG. 15 is a terminal device dedicated to downloading contents data and license, dispensing with the function of playing back contents data, which is a dissimilarity from the terminal device 4 including the download and playback unit 10, described with reference to FIG. 2. The download-dedicated terminal device 45 comprises a host interface unit 46, a memory card interface unit 47, and a data processing unit 48 and initially stores a contents license to decrypt the contents, playback time limit data that restricts access to the contents, and time data into the memory card 15 installed in the memory card interface unit 47. The data processing unit 48 outputs a request to deliver the contents license and certificate information retrieved from the memory card 15 through the host interface unit 46 to the outside, receives information that is returned in response to the request from, for example, the server 1 through the host interface unit 46, and stores the information into the memory card 15 through the memory card interface unit 47. The thus received information includes a contents key that is used to decrypt the contents, playback time limit data that restricts access to the contents and time data to be retained on the card. The above certificate information comprises information indicating that the memory card 15 has the within/out-of-time-limit decision function. Contents and its playback license can be distributed or sold through this download terminal device and to a memory card. The storage medium to which the contents should be copied is limited to the memory card 15 having the within/out-of-time-limit decision function. Consequently, this download terminal device can support prevention of fraudulent access to contents data with a usable time limit.

While the topology where the terminal device connects to the network is shown in FIG. 15, the embodiment is not so limited. Instead, the download terminal device 45 may be provided as a contents server or a stand-alone distribution terminal device from another perspective, but alternatives are not shown.

While the invention made by the present inventors has been described specifically, based on its preferred embodiments, it will be appreciated that the present invention is not limited to the illustrative embodiments and various changes may be made without departing from the scope of the invention.

For example, in the described embodiments, both contents and contents licenses are downloaded and distributed to the data terminals having the download function, but the invention is not so limited. In some implementation, it may be possible to download or distribute only contents licenses to the data terminals. In some implementation, contents may not be stored into the same memory card to which licenses are stored. In that case, contents data may be stored into removable storage media such as CD-ROMs and DVD-RAMs and accessed through removable disk drives or may be stored into hard disks and accessed through hard disk drives.

In the described embodiments, time data is encrypted, embedded into a license, and the license is stored into the secure area; however, encryption may not be applied. In that case, because time data is embedded into a license without being encrypted, processing loads are reduced. In some implementation, time data may be encrypted and stored into a non-secure region. The invention can be applied to storage media without a secure region as well. Time data may be stored into a non-secure region without being encrypted. The invention can be applied to storage media without a secure region as well and, because encryption/decryption processing by the AES need not be performed, the invention can be realized with a minimum number of components. However, attention should be paid to that the possibility that time data is manipulated by the user increases without encryption.

Advantages obtained by typical aspects of the invention disclosed in this application can be summarized as follows.

Time data like access time stamp information is updated and recorded on the nonvolatile memory device such as a memory card and updating the access time stamp is performed not only at the timing of end of access but also a plurality of points of time. Thus, even if power supply is turned off immediately before the termination of a playback of contents information, it is ensured that access time stamp information is updated at least once per access. The nonvolatile memory device is provided with the function to prevent a fraudulent playback of contents information whose usage is restricted to a time limit. Thus, it is easy to keep the function to prevent fraudulent access still working even after the playback device is replaced.

1. A nonvolatile memory device comprising a control circuit and a nonvolatile memory circuit,
wherein said nonvolatile memory circuit includes a storage region for restriction information that restricts access to contents information,
wherein said restriction information includes access time limit information and access time stamp information,
wherein said control circuit performs an access decision operation which decides whether access to said contents information is enabled or disabled, based on first time information which is supplied externally and said restriction information, and updating said access time stamp information based on said first time information,
wherein said control circuit decides that access is disabled in the case where said first time information is later than the access time limit given by the access time limit information or in the case where said first time information is earlier than the access time stamp given by said access time stamp information, in the case other than these cases, said control circuit decides that the access is enabled, and
wherein said control circuit performs the access decision operation, at least, at the start of access to said contents information and at the end of the access.

2. A nonvolatile memory device comprising a control circuit and a nonvolatile memory circuit,
wherein said nonvolatile memory circuit includes a storage region for restriction information that restricts access to contents information,
wherein said restriction information includes access time limit information and access time stamp information,
wherein said control circuit performs an access decision operation which decides whether access to said contents information is enabled or disabled, based on first time information which is supplied externally and said restriction information, and updating said access time stamp information based on said first time information,
wherein said control circuit decides that access is disabled in the case where said first time information is later than the access time limit given by the access time limit information or in the case where said first time information is earlier than the access time stamp given by said access time stamp information, in the case other than these cases, said control circuit decides that the access is enabled, and
wherein said control circuit performs the access decision operation, at least, when operating power supply to the nonvolatile memory device is turned on and when the operating power supply is turned off.

3. The nonvolatile memory device according to claim 1,
wherein said nonvolatile memory circuit includes a storage region for said contents information and said nonvolatile memory device allows a plurality of divisions of said contents information to be stored in separate locations and to be accessed discretely, and
wherein, after said access decision operation decides that initial access to one of the divisions is enabled, said access decision operation may be performed each time accessing each of or a given number of the remaining divisions of said contents information.

4. The nonvolatile memory device according to claim 3, wherein the divisions of said contents information are accessed in units of sectors.

5. The nonvolatile memory device according to claim 3, wherein the access decision operation for access to the divisions of said contents information is programmed such that the access decision operation for access to the second and subsequent divisions of said contents information decides that access is enabled even when the first time information is later than the access time limit given by the access time limit information.

6. The nonvolatile memory device according to claim 3, wherein said nonvolatile memory device is used, coupled to an external device capable of outputting said first time information, and said nonvolatile memory device is capable of outputting the divisions of said contents information to said external device.

7. The nonvolatile memory device according to claim 3, wherein said nonvolatile memory circuit is a nonvolatile semiconductor memory and is housed in a certain memory card casing having interface terminals for connection to an external device.

8. The nonvolatile memory device according to claim 1, wherein said restriction information is encrypted by said control circuit and stored into said nonvolatile memory circuit.

9. The nonvolatile memory device according to claim 8, wherein an encryption key that is used to encrypt said restriction information is attribute information unique to the nonvolatile memory device.

10. The nonvolatile memory device according to claim 1, wherein said control circuit is capable of outputting certificate information to the external in order to receive a contents information license including a contents key that is used to decrypt said contents information.

11. The nonvolatile memory device according to claim 10, wherein said control circuit receives said contents information license from the external and stores said contents information license into said nonvolatile memory circuit.

12. The nonvolatile memory device according to claim 11, wherein said control circuit stores time information that is received with said contents key into said nonvolatile memory circuit as initial information of said access time stamp information.

13. The nonvolatile memory device according to claim 1,
wherein said nonvolatile memory circuit comprises a restricted access region and an unrestricted access region,
wherein said restriction information is stored into the restricted access region, and
wherein said contents information is stored into the unrestricted access region.

14. The nonvolatile memory device according to claim 13, wherein said control circuit is allowed to write data into said restricted access region only after authentication is accepted from the external.

15. The nonvolatile memory device according to claim 14, wherein said restricted access region is to store a contents information license.

16. The nonvolatile memory device according to claim 14, wherein said control circuit is allowed to read data from said restricted access region only after certificate information given from the external is authenticated.

17-30. (canceled)
